(19) United States
(12) Patent Application Publication
(10) Pub. No.: US 2026/0158588 A1
(43) Pub. Date: Jun. 11, 2026

(54) SQUARE SHAPE TERMINAL LASER WELDING APPARATUS AND SQUARE SHAPE TERMINAL LASER WELDING METHOD

(71) Applicant: MPLUS CORP., Cheongju-si (KR)

(72) Inventors: Jong Sung KIM, Seongnam-si (KR); Kang Ho KO, Seoul (KR); Youngjun LEE, Cheonan-si (KR); Kyoung Jai CHA, Seongnam-si (KR)

(73) Assignee: MPLUS CORP., Cheongju-si (KR)

(21) Appl. No.: 18/972,714

(22) Filed: Dec. 6, 2024

(51) Int. Cl. B23K 26/06; B23K 26/28; B23K 26/70; B23K 101/36

(52) U.S. Cl. CPC B23K 26/0643; B23K 26/0648; B23K 26/28; B23K 26/703; B23K 2101/36

(57) ABSTRACT

The objective of the present invention is to provide a laser welding apparatus for square-shaped terminals, and the configuration of the present invention includes a rotation support frame 110, a laser head unit 120 rotatably supported on the rotation support frame 110, and a rotation drive unit 130 supported on the rotation support frame 110 and rotating the laser head unit 120. The present invention adopts a laser head (LASER HEAD) rotation method, which is a major component, to weld the round portion of the can and cap, and the laser head rotation method has the great advantage of being able to continuously weld the circumference of the can and cap at once, saving time and enhancing production speed.

### TECHNICAL FIELDS

The present invention relates to a laser welding apparatus for square-shaped terminals, and more particularly, to a laser welding apparatus for square-shaped terminals that secures an automatic welding process for assembling a secondary battery square can and cap.

### BACKGROUND TECHNOLOGIES

A secondary battery is made by stacking a separator on a plurality of positive plates, stacking a negative plate on the separator, stacking a positive plate again on the upper surface of the separator on the negative plate, and sequentially stacking separators and negative plates again. Secondary batteries can be recharged after use, and can be used repeatedly by reversing the discharge process to a certain extent, so they are commonly used in various electronic devices such as mobile phones, laptops, PDAs, etc. Secondary batteries are generally made by stacking a plurality of positive plates with positive polarity and a plurality of negative plates with negative polarity in multiple layers with separators interposed between the negative plates and positive plates. That is, an electrode assembly with a predetermined area is manufactured by interposing a separator between the positive plate and the negative plate, and stacking a plurality of positive and negative plates (hereinafter, for convenience of understanding, the positive plates and negative plates are collectively referred to as electrode plates), and such an electrode assembly is accommodated in a battery can, and electrolyte is injected into the interior of the battery can through one side opening of the battery can, and after completing charging and discharging of the electrode assembly put into the battery can of such a secondary battery, the manufacturing of the secondary battery is completed by sealing the one side opening of the battery can. The secondary battery cell is made by joining the battery can and cap of the secondary battery by welding and sealing the opening of the battery can.

However, existing welders had difficulty welding the corner round portion (corner R portion) when welding from the side of the can, so they mainly used a TOP method for welding and turned the entire CAN, but in this case, there was a problem that a cam drive was used during welding, making operation very difficult.

### PRIOR ART DOCUMENTS

### Patent Documents

Korean Registered Patent No. 10-0579391 (registered on May 4, 2006)
Korean Registered Patent No. 10-0670492 (registered on Jan. 10, 2007)
Korean Registered Patent No. 10-1467630 (registered on Nov. 25, 2014)

### DESCRIPTION OF THE INVENTION

### Problem to be Solved

The objective of the present invention is to provide a laser welding apparatus for square-shaped terminals that welds the entire circumference of the can and cap without interruption during welding of a secondary battery can and cap, and ensures consistent quality.

### Means to Solve the Problem

According to the present invention to achieve the above objective, a laser welding apparatus for square-shaped terminals is provided that includes a rotation support frame 110, a laser head unit 120 rotatably supported on the rotation support frame 110, and a rotation drive unit 130 supported on the rotation support frame 110 and rotating the laser head unit 120.

The laser head unit 120 includes a laser casing 122 supported on the rotation support frame 110, a lens 126 provided inside the laser casing 122, a mirror unit 124 provided inside the laser casing 122, and a laser head 128 provided at the front end of the laser casing 122 and having a laser emission hole.

The mirror unit 124 includes a rear mirror 124RM provided in the laser transmission path inside the laser casing 122 to be placed toward the laser inlet of the laser casing 122, an intermediate mirror 124MM placed between the rear mirror 124RM and the laser emission hole at the front end of the laser casing 122 in the interior of the laser casing 122, and a pair of first front mirror 124FFM and second front mirror 124SFM placed between the intermediate mirror 124MM and the laser emission hole at the front end of the laser casing 122.

The pair of first front mirror 124FFM and second front mirror 124SFM are placed facing each other, and the first front mirror 124FFM is placed in a position facing the intermediate mirror 124MM.

The rotation drive unit 130 includes a rotation drive motor 132 mounted on the rotation support frame 110, a rotation drive pulley 134 with its center portion coaxially connected to the motor shaft of the rotation drive motor 132, a rotation driven pulley 136 mounted on the rotation support frame 110 and having the laser casing 122 connected to its center portion, and a rotation drive belt 138 connected to the outer circumferential surfaces of the rotation drive pulley 134 and rotation driven pulley 136.

The laser head unit 120 is configured to rotate at the R value rotation center axis, which is the radius of curvature value of the curved section of the can 10 and cap 12.

The laser transmission path of the laser casing 122 is further provided with a protective glass PG and a nitrogen purge port N2 PURGE.

The laser head unit 120 is further provided with a cooling unit 140.

According to the present invention, there is provided a laser welding method of square-shaped terminals using a laser welding apparatus for square-shaped terminals including a rotation support frame 110, a laser head unit 120 rotatably supported on the rotation support frame 110, and a rotation drive unit 130 supported on the rotation support frame 110 and rotating the laser head unit 120, which includes a linear section welding step of laser welding a linear welding section of a secondary battery square can 10 and cap 12 by the laser head unit 120, and a curved section welding step of rotating the laser head unit 120 when the laser head unit 120 reaches a curved section of the secondary battery square can 10 and the cap 12 to weld the curved section of the secondary battery square can 10 and cap 12.

### Effects of the Invention

The present invention adopts a laser head rotation method, which is a major component, to weld the round portion of the can and cap, and the laser head rotation method has the great advantage of being able to continuously weld the circumference of the can and cap at once, saving time and enhancing production speed.

### BRIEF DESCRIPTION OF THE DRAWINGS

FIG. 1 is a perspective view of a laser welding apparatus for square-shaped battery terminals according to the present invention,

FIG. 2 is a perspective view showing the laser head portion and the can and cap portion, which are major components, of the laser welding apparatus for square-shaped battery terminals according to the present invention,

FIG. 3 is an enlarged view of the major components of FIG. 2,

FIG. 4 is a view showing an enlarged view of the Y-axis transfer unit and Z-axis transfer unit, which are major components, shown in FIG. 2,

FIG. 5 is a left-side perspective view of FIG. 2,

FIG. 6 is an enlarged view of the major components of FIG. 5,

FIG. 7 is a plan view of the laser welding apparatus for square-shaped battery terminals according to the present invention,

FIG. 8 is a half-cut perspective view showing the internal structure of the laser head unit which are major components of the present invention,

FIG. 9 is a half-cut perspective view schematically showing the path through which the laser is transferred to the interior of the laser casing of the laser head unit shown in FIG. 8,

FIG. 10 is a view schematically showing the structure of the laser head unit, rotation drive unit, and cooling unit, which are major components of the present invention,

FIG. 11 is a view schematically showing the rotation of the laser head unit, which is a major component of the present invention, and the operation states of the Z-axis transfer unit and Y-axis transfer unit,

FIG. 12 is a view schematically showing the rotational operation of the laser head unit, which is a major component of the present invention,

FIG. 13 is a front view schematically showing the process of welding the curved section of the can and cap by the laser head, which is a major component of the present invention,

FIG. 14 is a front view showing an enlarged part of the process of welding the curved section of the can and cap by the laser head, which is a major component of the present invention,

FIG. 15 is a view showing an enlarged view of the laser head and the can and cap portion, which are major components of the present invention,

FIG. 16 is a view showing an enlarged view of the process of welding the can and cap by the laser head shown in FIG. 15,

FIG. 17 is a view showing the structure of the Z-axis transfer unit and Y-axis transfer unit, which are major components of the present invention, from the left side,

FIG. 18 is an enlarged view of part A of FIG. 17,

FIG. 19 is a view schematically showing the cooling water movement section by the cooling unit, which is a major component of the present invention.

### DETAILED DESCRIPTION OF THE INVENTION

Hereinafter, preferred embodiments of the present invention will be described in detail with reference to the accompanying drawings. The purpose, features, and advantages of the present invention will be more easily understood by reference to the accompanying drawings and the following detailed description. Also, when describing the present invention, a detailed description of known structures or functions may be omitted if it is deemed that the detailed description would obscure the point of the present invention.

Also, in describing the components of the present invention, terms such as first, second, A, B, (a), (b), etc. may be used. These terms are only to distinguish one component from other components, and the nature, order, or sequence, etc. of the corresponding component is not limited by those terms. For example, when a component is described as being “connected”, “coupled”, or “connected” to another component, it should be understood that the component may be directly connected or connected to the other component, but “connected”, “coupled”, or “connected” between each component may also be another component.

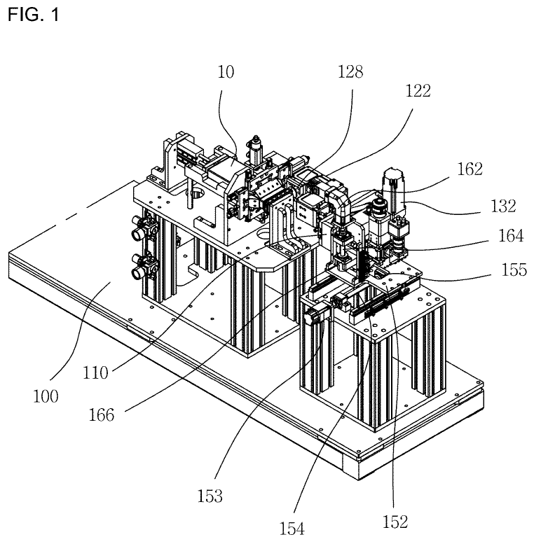

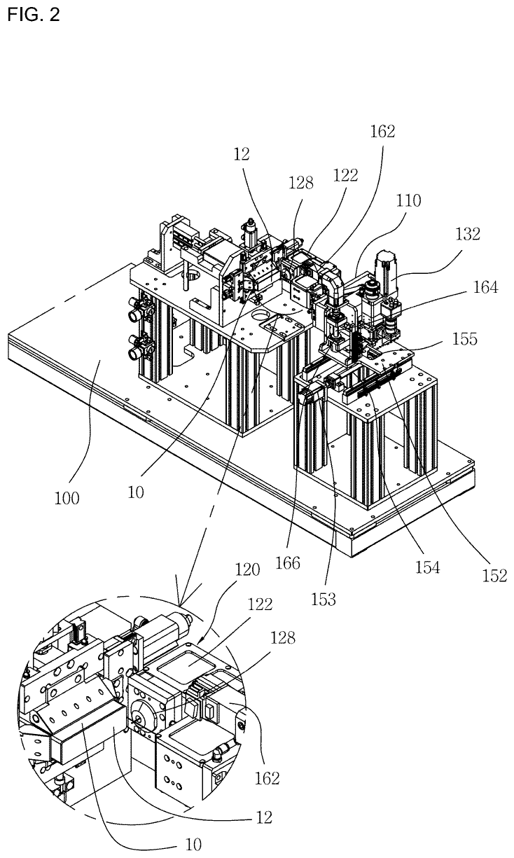

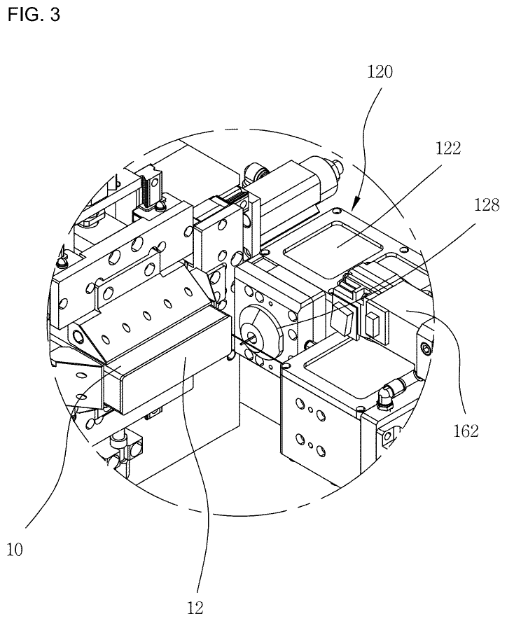

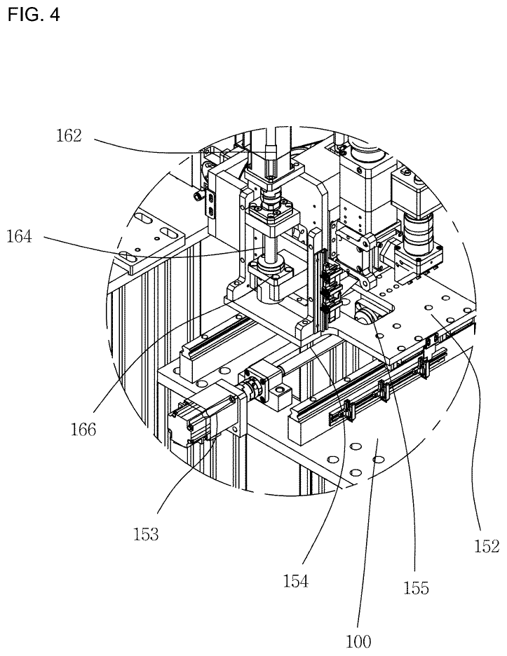

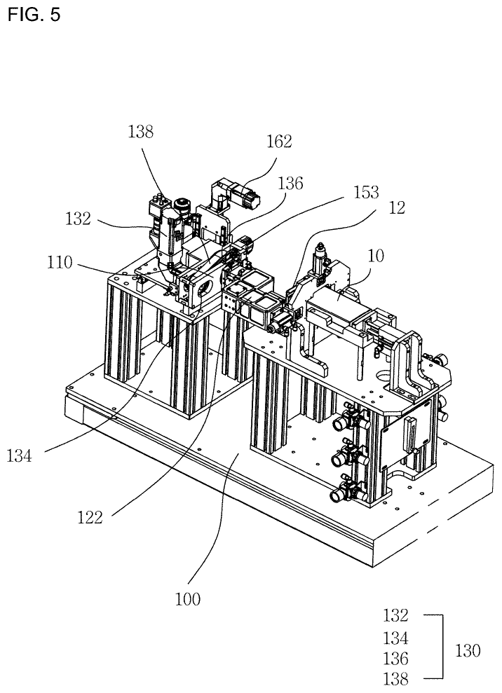

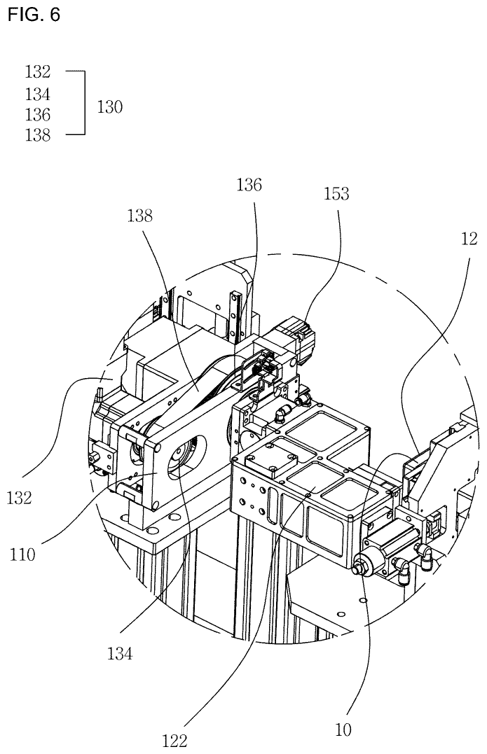

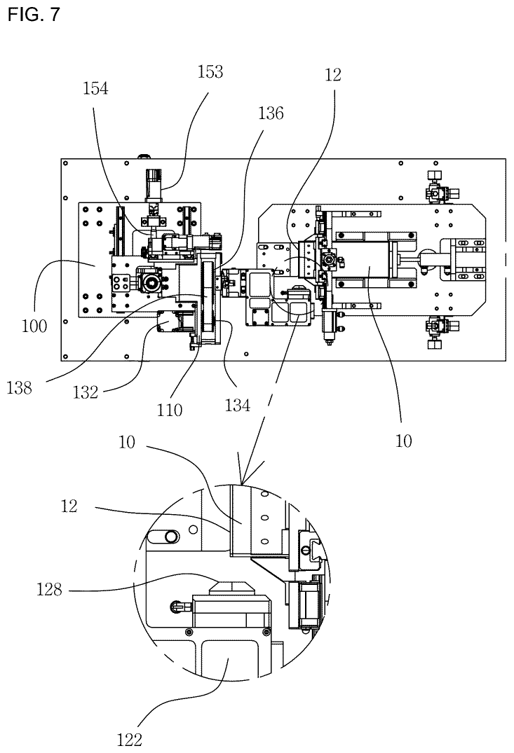

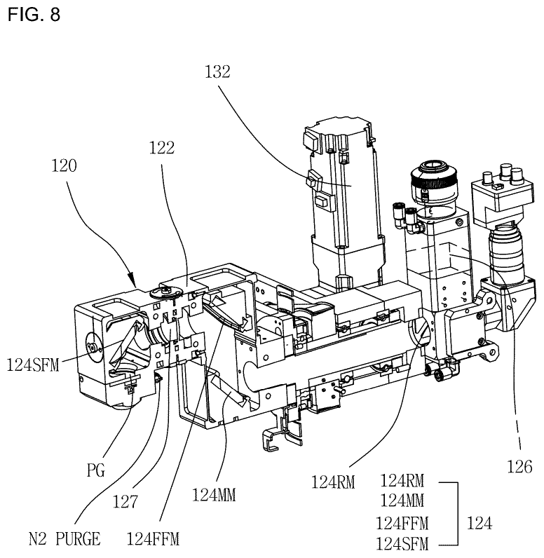

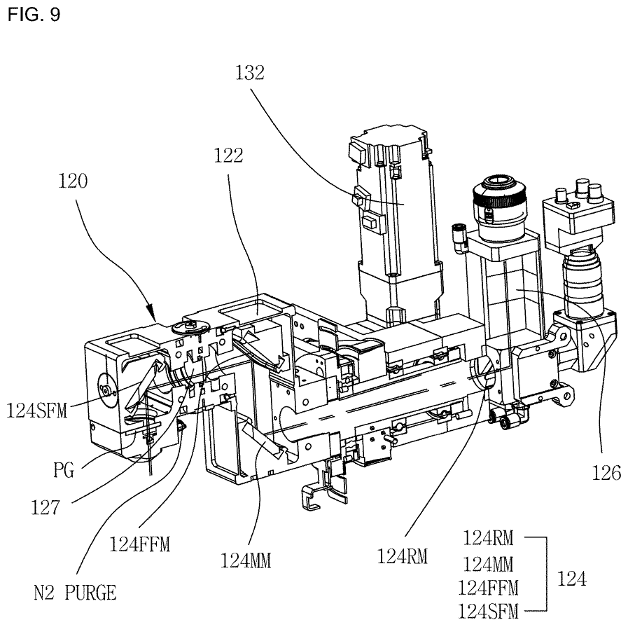

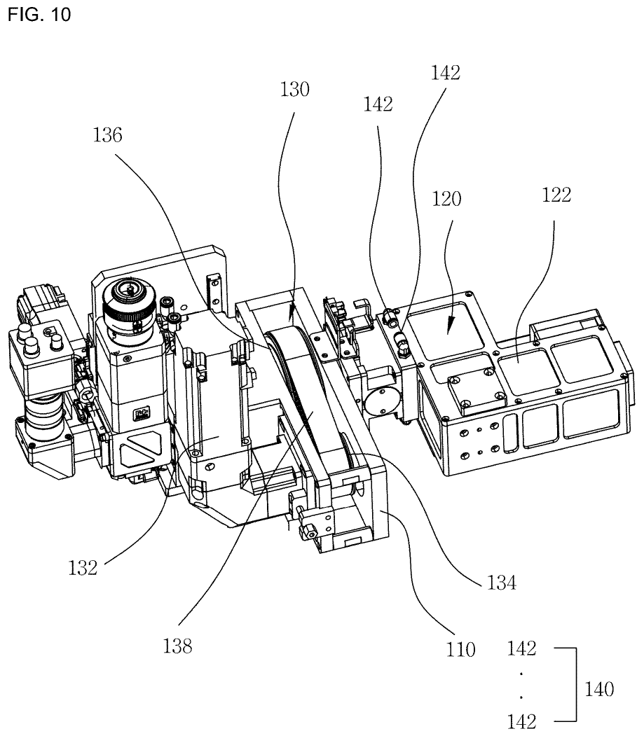

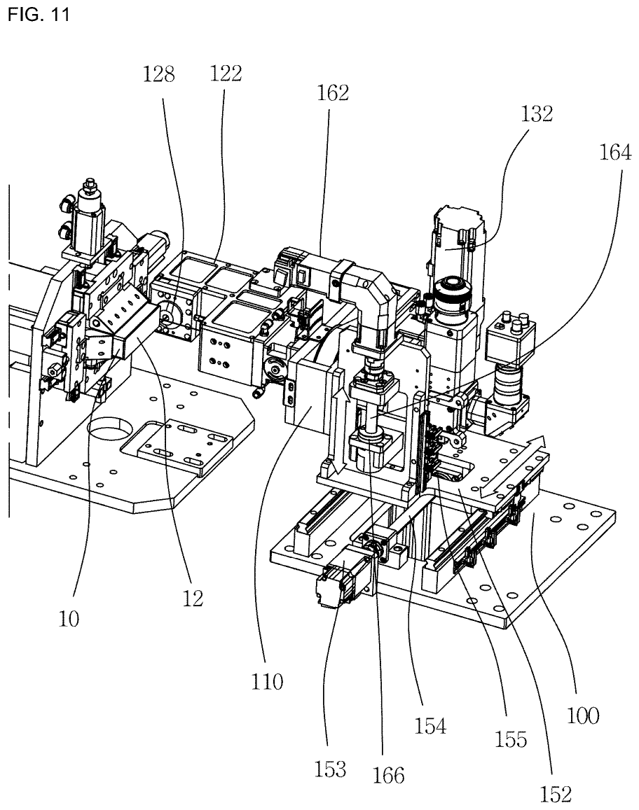

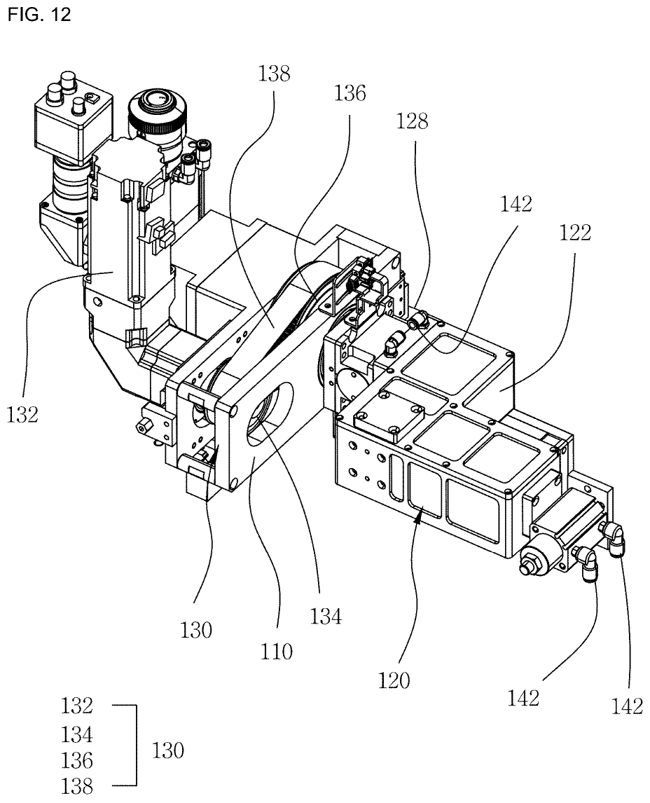

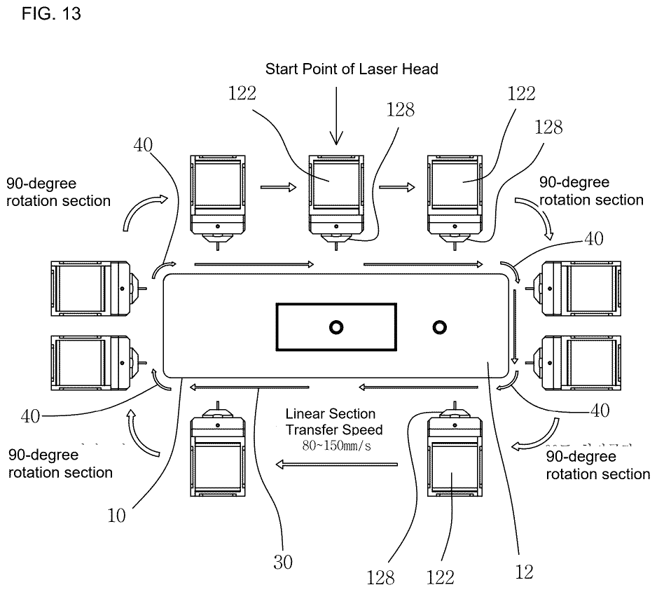

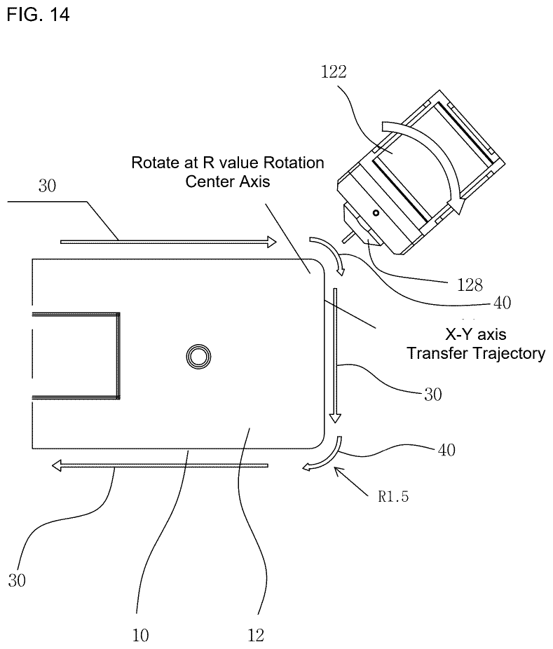

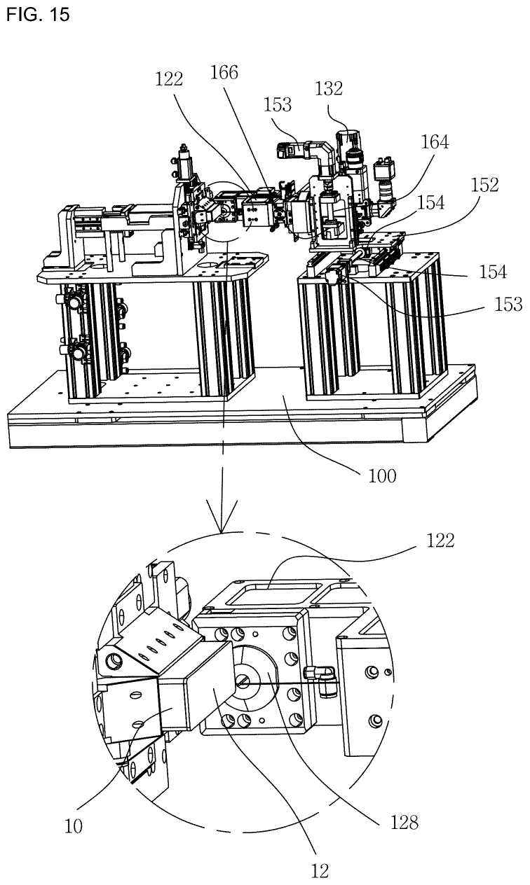

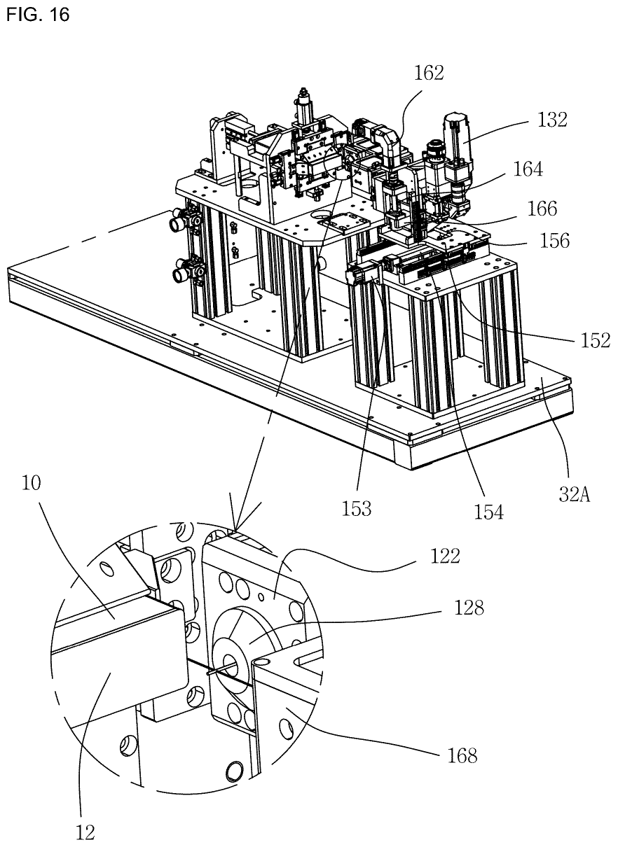

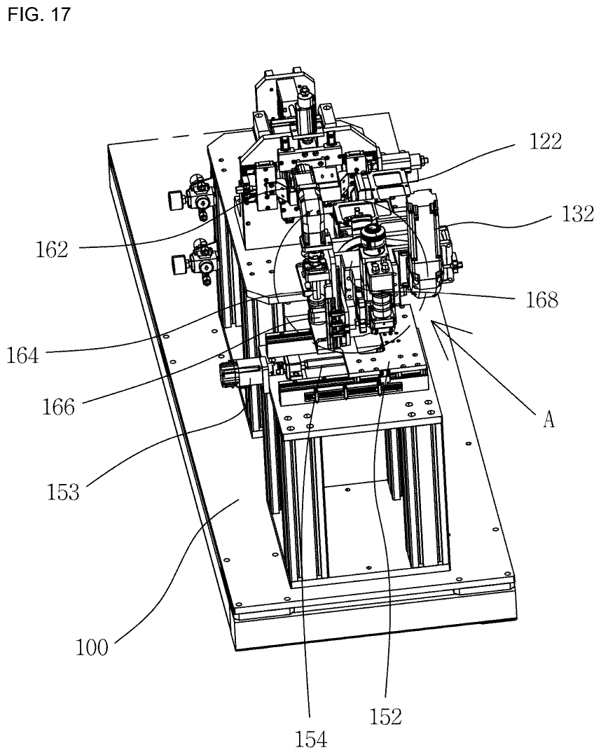

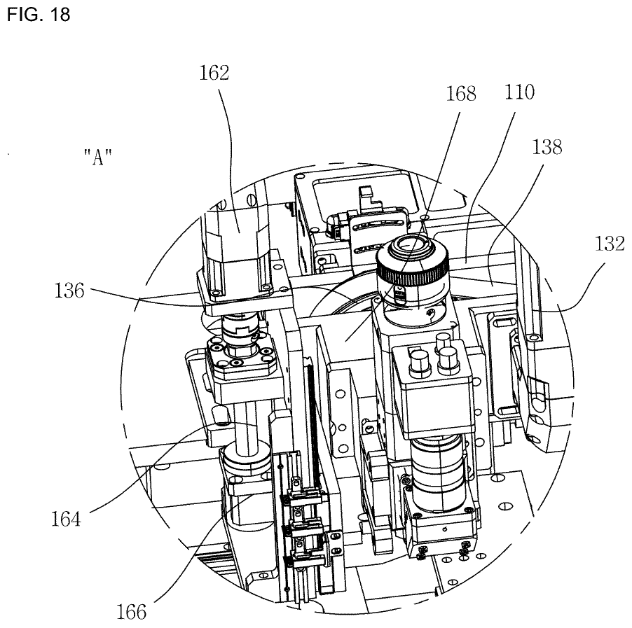

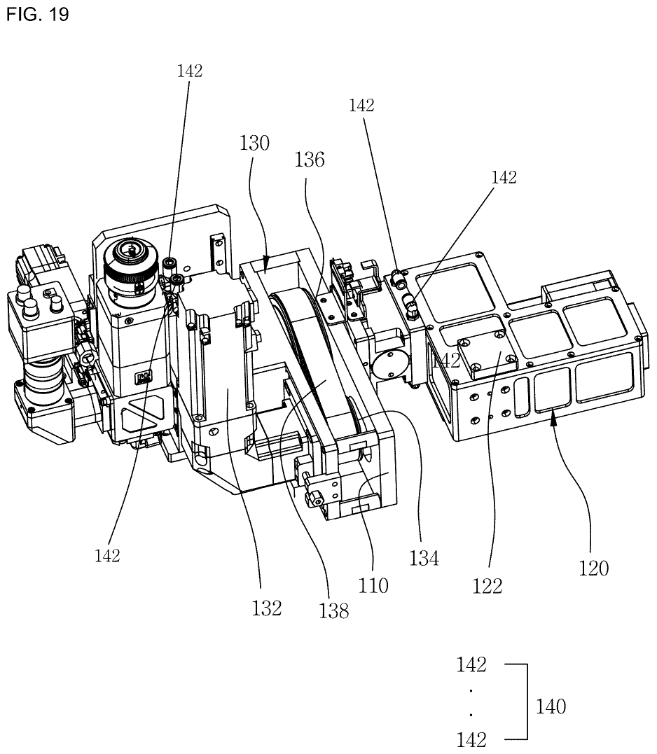

FIG. 1 is a perspective view of a laser welding apparatus for square-shaped terminals according to the present invention, FIG. 2 is a perspective view showing the major components of the laser head portion and the can and cap portion of the laser welding apparatus for square-shaped terminals according to the present invention, FIG. 3 is an enlarged view of the major components of FIG. 2, FIG. 4 is a view showing an enlarged view of the Y-axis transfer unit and Z-axis transfer unit, which are major components, shown in FIG. 2, FIG. 5 is a left-side perspective view of FIG. 2, FIG. 6 is an enlarged view of the major components of FIG. 5, FIG. 7 is a plan view of the laser welding apparatus for square-shaped terminals according to the present invention, FIG. 8 is a half-cut perspective view showing the internal structure of the laser head unit and the structure of the mirror unit, which are major components of the present invention, FIG. 9 is a half-cut perspective view schematically showing the path through which the laser is transferred to the interior of the laser casing of the laser head unit shown in FIG. 8, FIG. 10 is a view schematically showing the structure of the laser head unit, rotation drive unit, and cooling unit, which are major components of the present invention, FIG. 11 is a view schematically showing the rotation of the laser head unit, which is a major component of the present invention, and the operation states of the Z-axis transfer unit and Y-axis transfer unit, FIG. 12 is a view schematically showing the rotational operation of the laser head unit, which is a major component of the present invention, FIG. 13 is a front view schematically showing the process of welding the curved section of the can and cap by the laser head, which is a major component of the present invention, FIG. 14 is a front view showing an enlarged part of the process of welding the curved section of the can and cap by the laser head, which is a major component of the present invention, FIG. 15 is a view showing an enlarged view of the laser head and the can and cap portion, which are major components of the present invention, FIG. 16 is a view showing an enlarged view of the process of welding the can and cap by the laser head shown in FIG. 15, FIG. 17 is a view showing the structure of the Z-axis transfer unit and Y-axis transfer unit, which are major components of the present invention, from the left side, FIG. 18 is an enlarged view of part A of FIG. 17, FIG. 19 is a view schematically showing the cooling water movement section by the cooling unit, which is a major component of the present invention.

Referring to the drawings, the laser welding apparatus for square-shaped terminals according to the present invention basically includes a rotation support frame 110, a laser head unit 120 rotatably supported on the rotation support frame 110, and a rotation drive unit 130 supported on the rotation support frame 110 and rotating the laser head unit 120.

The rotation support frame 110 is configured as a hexahedral frame shape with an internal space and open upper and lower ends. The rotation support frame 110 is installed so as to be supported on a main frame 100. A Y-axis transfer frame 152 that can be transferred along the Y-axis direction is installed on the main frame 100, and the rotation support frame 110 is mounted on the Y-axis transfer frame 152, so that the rotation support frame 110 takes a structure installed so as to be supported on the main frame 100.

The laser head unit 120 includes a laser casing 122, a lens 126, a mirror unit 124, and a laser head 128.

The laser casing 122 is supported on the rotation support frame 110. As shown in FIG. 6, the laser casing 122 is configured to include a front casing portion in the shape of a Korean letter “¬” (giyeok), and a rear casing portion in a linear line shape connected to the front casing portion. A laser head 128 with a laser emission hole is provided at the front end of the laser casing 122, and a laser inlet is provided at the rear end, and the laser generated from the laser device enters the laser progression path of the laser casing 122 through the laser inlet, and the laser is configured to be emitted through the laser emission hole provided in the laser head 128 at the front end of the laser casing 122. That is, the laser enters through the laser inlet provided in the rear casing portion of the laser casing 122, passes through the laser progression path inside the rear casing portion and the front casing portion, and is emitted through the laser emission hole of the laser head 128 provided at the front end of the front casing portion, and the secondary battery square can 10 and cap 12 can be laser welded by the emitted laser.

In the present invention, there is a structure in which a rear laser transmission path and a front laser transmission path are provided inside the rear casing and the front casing, respectively, but hereinafter, for convenience of explanation, the rear laser transmission path and the front laser transmission path inside the rear casing and the front casing will be referred to as the laser transmission path inside the laser casing.

The lens 126 is placed toward the laser inlet of the laser casing 122. The laser entering from the laser inlet of the laser casing 122 passes through the lens 126. The mirror unit 124 is provided inside the laser casing 122.

The mirror unit 124 includes a rear mirror 124RM, an intermediate mirror 124MM, a first front mirror 124FFM, and a second front mirror 124SFM.

Referring to FIG. 9, the rear mirror 124RM is provided in the laser transmission path inside the laser casing 122. The rear mirror 124RM takes a structure placed on the laser transmission path inside the laser casing 122 to be placed toward the laser inlet provided in the laser casing 122. The rear mirror 124RM reflects the laser entering from the laser inlet of the laser casing 122 to advance along the laser transmission path inside the laser casing 122.

Referring to FIGS. 8 and 9, the rear mirror 124RM of the mirror unit 124 is configured to be placed in front of the lens 126 in the laser transmission path inside the laser casing 122.

The laser entering from the laser inlet of the laser casing 122 passes through the lens 126, is reflected by the rear mirror 124RM, and advances toward the intermediate mirror 124MM of the mirror unit 124.

The intermediate mirror 124MM is placed on the laser transmission path inside the laser casing 122. The intermediate mirror 124MM is placed between the laser emission hole at the front end of the laser casing 122 and the rear mirror 124RM. The intermediate mirror 124MM reflects the laser reflected from the rear mirror 124RM to advance toward the first front mirror 124FFM above.

The pair of first front mirror 124FFM and second front mirror 124SFM are placed between the intermediate mirror 124MM and the laser emission hole at the front end of the laser casing 122.

The first front mirror 124FFM and the second front mirror 124SFM are placed facing each other, so that the laser reflected from the intermediate mirror 124MM is reflected from the first front mirror 124FFM toward the second front mirror 124SFM, and is emitted through the laser emission hole at the front end of the laser casing 122 (i.e., the laser emission hole provided in the laser head 128) to laser weld the linear and curved sections between the secondary battery square can 10 and cap 12.

At this time, a front lens 127 is further provided in the transmission path of the laser casing 122 to be placed between the first front mirror 124FFM and the second front mirror 124SFM, so that the laser passing through the front lens 127 advances toward the second front mirror 124SFM.

At the front end of the laser casing 122, a laser head 128 is provided, and the laser head 128 has a laser emission hole, so that the laser transferred along the laser transmission path inside the laser casing 122 can be emitted through the laser emission hole of the laser head 128, and the linear and curved sections between the secondary battery square can 10 and cap 12 can be laser welded by the laser emitted through the laser emission hole of the laser head 128.

Meanwhile, a protective glass PG is further provided in the laser transmission path of the laser casing 122, placed between the laser head 128 and the second front mirror 124SFM.

The protective glass PG prevents foreign substances from the outside from penetrating into the laser transmission path inside the laser casing 122 through the laser emission hole of the laser head 128 provided at the front end of the laser casing 122.

Also, a nitrogen purge port N2 PURGE is further provided in the laser casing 122, placed between the protective glass PG and the laser emission hole of the laser head 128, so that nitrogen gas is injected into the internal laser transmission path of the laser casing 122 through the nitrogen purge port N2 PURGE when the laser is emitted through the laser emission hole of the laser head 128, thereby preventing foreign substances such as dust from the outside from penetrating into the laser transmission path inside the laser casing 122.

The rotation drive unit 130 includes a rotation drive motor 132 mounted on the rotation support frame 110, a rotation drive pulley 134 with its center portion coaxially connected to the motor shaft of the rotation drive motor 132, a rotation driven pulley 136 mounted on the rotation support frame 110 and having the laser casing 122 connected to its center portion, and a rotation drive belt 138 connected to the outer circumferential surfaces of the rotation drive pulley 134 and rotation driven pulley 136.

The center portion of the rotation driven pulley 136 is configured to be connected to the middle portion of the laser casing 122, so that when the rotation driven pulley 136 rotates on the rotation support frame 110, the laser casing 122 is configured to rotate at a 360-degree angle. In other words, the rotation drive pulley 134 rotates by the drive of the rotation drive motor 132, and the rotation power of the motor shaft of the rotation drive motor 132 is transferred to the rotation driven pulley 136 by the rotation drive belt 138, so that the laser head unit 120 rotates at a 360-degree angle on the rotation support frame 110 and laser welds the curved section of the secondary battery square can 10 and cap 12 (i.e., the square-shaped terminal).

Also, in the present invention, the laser head unit 120 is further provided with a cooling unit 140.

The cooling unit 140 may include a chamber forming case that secures a cooling chamber between the outer surface of the laser casing 122, and a cooling water circulation port 142 provided in the chamber forming case to allow cooling water to flow into the interior of the cooling chamber and to discharge cooling water after heat exchange is performed (i.e., heat exchange with heat generated when laser welding the secondary battery square can 10 and cap 12 with the laser). At this time, a plurality of cooling water circulation ports 142 may be composed of a cooling water inlet port and a cooling water outlet port.

Meanwhile, according to the present invention, a laser welding method of square-shaped terminals is provided using a laser welding apparatus for square-shaped terminals including a rotation support frame 110, a laser head unit 120 rotatably supported on the rotation support frame 110, and a rotation drive unit 130 supported on the rotation support frame 110 and rotating the laser head unit 120.

The present invention provides a laser welding method of square-shaped terminals characterized by including a linear section welding step of transferring the rotation drive unit 130, the laser head unit 120, and the rotation drive unit 130 along the linear section of the secondary battery square can 10, which is the welding target, and laser welding the linear welding section of the secondary battery square can 10 and cap 12, and a curved section welding step of transferring the rotation drive unit 130, the laser head unit 120, and the rotation drive unit 130 in the Y-axis direction, and when the laser head unit 120 reaches the curved section of the secondary battery square can 10 and the cap 12, rotating the laser head unit 120 by the rotation drive unit 130 to weld the curved section of the secondary battery square can 10 and cap 12.

The process of laser welding (square-shaped terminal laser welding) the secondary battery square can 10 and cap 12 according to the configuration of the present invention described above will be explained as follows.

Hereinafter, for convenience of explanation, the secondary battery square can 10 and cap 12 will be referred to as a square-shaped terminal. Also, laser welding will be referred to as welding for convenience of explanation.

First, as shown in FIG. 12, the laser welding starts by transferring the laser head 128 along the Y-axis direction by the drive of the Y-axis transfer unit from the linear section of the square-shaped terminal.

At this time, the Y-axis transfer unit includes a Y-axis transfer frame 152 coupled to the main frame 100 via an LM guide placed in the Y-axis direction and transferable in the Y-axis direction, a Y-axis transfer drive motor 154 mounted on the main frame 100 and having its motor shaft placed parallel to the Y-axis direction, a Y-axis transfer ball screw 154 coaxially connected to the motor shaft of the Y-axis transfer drive motor 154, and a Y-axis transfer ball screw nut 155 coupled to the outer circumferential surface of the Y-axis transfer ball screw 154 and coupled to the Y-axis transfer frame 152.

Also, the major components of the present invention, the rotation support frame 110, the laser head unit 120, and the rotation drive unit 130, are coupled to the Z-axis transfer unit mounted on the Y-axis transfer frame 152, so that the rotation support frame 110, the laser head unit 120, and the rotation drive unit 130 are configured to be elevated in the Z-axis direction.

At this time, the Z-axis transfer unit includes a Z-axis transfer drive motor 162 mounted on the Y-axis transfer frame 152 (specifically, mounted on the vertical mounting support frame part of the Y-axis transfer frame 152) and having its motor shaft placed in a vertical direction parallel to the Z-axis direction, a Z-axis transfer ball screw 164 coaxially coupled to the motor shaft of the Z-axis transfer drive motor 162, a Z-axis transfer ball screw nut 166 coupled to the outer circumferential surface of the Z-axis transfer ball screw 164, and a Z-axis transfer connection frame 168 coupled to the Z-axis transfer ball screw nut 166 and coupled to the rotation support frame 110 that rotatably supports the laser head unit 120.

According to the forward and reverse rotation of the motor shaft of the Y-axis transfer drive motor 154, the Y-axis transfer ball screw 154 also rotates forward and backward, and the Y-axis transfer ball screw nut 155 moves forward and backward in the Y-axis direction on the outer circumferential surface of the Y-axis transfer ball screw 154, so the Y-axis transfer frame 152, the Z-axis transfer unit, the rotation support frame 110, the laser head unit 120, and the rotation drive unit 130 move forward and backward along the Y-axis direction.

Meanwhile, according to the forward and reverse rotation of the motor shaft of the Z-axis transfer drive motor 162, the Z-axis transfer ball screw 164 also rotates forward and backward, and the Z-axis transfer ball screw nut 166 is elevated in the Z-axis direction on the outer circumferential surface of the Z-axis transfer ball screw 164, so the Z-axis transfer connection frame 168, the rotation support frame 110, the laser head unit 120, and the rotation drive unit 130 are elevated along the Z-axis direction.

Since the curved section (corner R section) must be welded together with the linear section when welding the can 10 (CAN) and cap 12 (CAP) of the square-shaped terminal at a speed that matches the production speed, in the present invention, the drive of the laser head 128 moves synchronously at a 360-degree angle at the vertex (i.e., the corner portion where each side of the square-shaped terminal meets) with 90 degrees of angle at each of the 4 locations where the sides meet, with the rotation of the laser head (Laser head), X,Y,Z stage (STAGE), and the theta-axis of the clamp unit.

FIG. 13 is a view showing the laser welding trajectory of the laser head 128, which is a major component of the present invention, on the can 10 and cap 12 of the square secondary battery side terminal. The laser head 128 is transferred continuously along the welding trajectory to perform the welding operation.

Also, FIG. 14 explains the linear welding transfer trajectory 30 and the curved welding transfer trajectory 40, which are the laser transfer trajectories of the laser head 128 on the can 10 and cap 12 of the square-shaped terminal, and is a view showing an enlarged view of the process of welding the curved section of the square-shaped terminal while rotating along the curved welding transfer trajectory 40. The present invention has a key feature in that it can weld the curved welding section trajectory of the square-shaped terminal smoothly and reliably.

While proceeding with the welding work along the linear welding transfer trajectory 30 and the curved welding transfer trajectory 40, the linear velocity may be set differently to make the laser heat amount delivered for welding uniform and to make the welding quality good, and the welding work may also be proceeded with by inputting different laser outputs.

In the present invention, the laser head unit 120 is configured to rotate at the R value rotation center axis, which is the radius of curvature value of the curved section of the can 10 and cap 12. In other words, at the corner curved section (corner R portion) of the square-shaped terminal, it rotates 90 degrees at the curve radius value center (R value center) and continuously drives by adjusting the RPM to be the same as the linear section speed.

Therefore, it can be expected to reliably improve the welding precision for the curved section of the can 10 and cap 12.

As shown in FIG. 10, the present invention laser welds the linear welding section of the square-shaped terminal (i.e., the linear welding section of the secondary battery square can 10 and cap 12) while transferring the rotation drive unit 130, the laser head unit 120, and the rotation drive unit 130 along the linear section of the secondary battery square can 10, which is the welding target, by the drive of the Y-axis transfer unit. The rotation drive unit 130, the laser head unit 120, and the rotation drive unit 130 move forward and backward along the Y-axis direction, and the laser head 128 of the laser head unit 120 moves forward and backward along the Y-axis direction, and the linear welding section of the square-shaped terminal is welded by the laser emitted from the laser emission hole of the laser head 128. This step is the linear section welding step.

Referring to FIG. 10, the present invention welds the upper and lower two linear welding sections and the front and rear two linear welding sections of the square-shaped terminal with the laser head 128. Specifically, the rotation drive unit 130, the laser head unit 120, the rotation drive unit 130, and the laser head 128, which are the major components of the laser head unit 120, are transferred in the Y-axis direction along the upper and lower two linear welding sections of the square-shaped terminal, and the upper and lower two linear welding sections and the front and rear two linear welding sections of the square-shaped terminal are welded by the laser emitted from the laser emission hole of the laser head 128. For reference, the linear section transfer speed is 80˜150 mm/s.

Meanwhile, as shown in FIG. 10, during the linear section welding step, while welding the linear section of the square-shaped terminal, when the laser head 128, which is the major components of the laser head unit 120, reaches the curved welding section of the square-shaped terminal, the laser head unit 120 is rotated by the rotation drive unit 130 based on the rotation support frame 110, which is the major component of the rotation drive unit 130, and the curved welding section of the square-shaped terminal is welded by the laser emitted from the laser emission hole of the laser head 128.

Referring to FIG. 10, the present invention welds with the major components, the laser head 128, rotating at the four curved welding sections (i.e., 90-degree rotation sections) of the square-shaped terminal. Specifically, the rotation drive unit 130, the laser head unit 120, the rotation drive unit 130, and the laser head 128, which is the major component of the laser head unit 120, rotate along the curved welding sections of the four corner portions of the square-shaped terminal and weld the curved welding sections of the four corner portions of the square-shaped terminal with the laser emitted from the laser emission hole of the laser head 128. This step is the curved section welding step.

Therefore, the present invention adopts a laser head 128 (LASER HEAD) rotation method as major component to weld the round portion of the can 10, and the laser head 128 rotation method has the great advantage of being able to continuously weld the circumference of the can 10 and cap 12 at once, saving time and enhancing production speed.

The present invention has the effect of further enhancing the welding efficiency of the square-shaped terminal because the mirror unit 124 provided inside the laser casing 122 and the lens 126 provided inside the laser casing 122 are further provided, so that the laser transferred along the laser transmission path inside the laser casing 122 passes through the lens 126, increasing the laser filtering efficiency, and the laser is more smoothly emitted through the laser emission hole of the laser head 128.

In particular, the laser passing through the front lens 127 is configured to advance toward the second front mirror 124SFM, so the laser transferred along the laser transmission path inside the laser casing 122 passes through the front lens 127, further increasing the laser filtering efficiency, and the laser is even more smoothly emitted through the laser emission hole of the laser head 128, which has the effect of even further enhancing the welding efficiency of the square-shaped terminal.

Also, the present invention includes the rear mirror 124RM, the intermediate mirror 124MM, and the pair of first front mirror 124FFM and second front mirror 124SFM provided in the laser casing 122, so the laser is reflected through the rear mirror 124RM, the intermediate mirror 124MM, and the pair of first front mirror 124FFM and second front mirror 124SFM along the laser transmission path of the laser casing 122, and the laser is even more smoothly emitted through the laser emission hole of the laser head 128, which has the effect of even further enhancing the welding efficiency of the square-shaped terminal, and also can be expected to have the effect of maximally simplifying the reflection structure for laser transmission.

Meanwhile, the present invention has the cooling unit 140 further provided in the laser head unit 120, so that when the laser head unit 120 is overheated due to laser emission during the square-shaped terminal welding operation, it is cooled by the cooling unit 140, which has the effect of preventing damage to the laser head unit 120 due to overheating, and also has the effect of helping to improve the welding quality of the square-shaped terminal.

In the above, the terms “include”, “comprise”, or “have”, etc., unless there is a specific statement to the contrary, mean that the corresponding component may be inherent, so it should be interpreted as not excluding other components but as possibly including other components. All terms including technical or scientific terms, unless defined otherwise, should have the same meanings as generally understood by those skilled in the art to which the present invention belongs. Terms such as those defined in a dictionary that are generally used should be interpreted as having meanings consistent with their meanings in the context of the relevant art and should not be interpreted in an idealized or overly formal sense unless expressly defined in the present invention.

The above description is merely an exemplary illustration of the technical idea of the present invention, and those skilled in the art to which the present invention belongs may make various modifications and variations within the scope not departing from the essential characteristics of the present invention. Therefore, the embodiments disclosed in the present invention are not intended to limit the technical idea of the present invention but to explain it, and the scope of the technical idea of the present invention is not limited by these embodiments. The protective scope of the present invention should be interpreted according to the following claims, and all technical ideas within an equivalent scope should be interpreted as being included in the right scope of the present invention.

Therefore, the embodiments described above are provided to those skilled in the art to which the present invention belongs to fully inform the scope of the invention, so they should be understood as being exemplary in all aspects and not limiting, and the present invention is defined only by the scope of the claims.

[REFERENCE NUMERALS]

| | |
|---|---|
| 10. Can | 12. Cap |
| 20. Laser | 30. Linear welding |
| | transfer trajectory |
| 40. Curved welding | 100. Main frame |
| transfer trajectory | |
| 110. Rotation support frame | 120. Laser head unit |
| 122. Laser casing | 124. Mirror unit |
| 124RM. Rear mirror | 124MM. Intermediate mirror |
| 124FFM. First front mirror | 124SFM. Second front mirror |
| 126. Lens | 127. Front lens |
| 128. Laser head | 130. Rotation drive unit |
| 132. Rotation drive motor | 134. Rotation drive pulley |
| 136. Rotation driven pulley | 138. Rotation drive belt |
| 140. Cooling unit | 142. Cooling water port |
| 152. Y-axis transfer frame | 153. Y-axis transfer drive motor |
| 154. Y-axis transfer ball screw | 155. Y-axis transfer ball screw nut |
| 162. Z-axis transfer drive motor | 164. Z-axis transfer ball screw |
| 166. Z-axis transfer ball screw nut | 168. Z-axis transfer connection frame |
| PG. Protective glass | N2 PUGRE. Nitrogen purge port |

1. A laser welding apparatus for square-shaped terminals, comprising:
a rotation support frame;
a laser head unit rotatably supported on the rotation support frame; and
a rotation drive unit supported on the rotation support frame and rotating the laser head unit.

2. The laser welding apparatus for square-shaped terminals according to claim 1, wherein the laser head unit includes:
a laser casing supported on the rotation support frame;
a lens provided inside the laser casing;
a mirror unit provided inside the laser casing; and
a laser head provided at a front end of the laser casing and having a laser emission hole.

3. The laser welding apparatus for square-shaped terminals according to claim 2, wherein the mirror unit includes:
a rear mirror provided in a laser transmission path inside the laser casing to be placed toward a laser inlet of the laser casing;
an intermediate mirror placed between the laser emission hole at the front end of the laser casing and the rear mirror; and
a pair of first front mirror and second front mirror placed between the intermediate mirror and the laser emission hole at the front end of the laser casing,
wherein a front lens is further provided in the transmission path of the laser casing to be placed between the first front mirror and the second front mirror.

4. The laser welding apparatus for square-shaped terminals according to claim 3, wherein the pair of first front mirror and second front mirror are placed facing each other, and the first front mirror is placed in a position facing the intermediate mirror.

5. The laser welding apparatus for square-shaped terminals according to claim 1, wherein the rotation drive unit includes:
a rotation drive motor mounted on the rotation support frame;
a rotation drive pulley with its center portion coaxially connected to a motor shaft of the rotation drive motor;
a rotation driven pulley mounted on the rotation support frame and having a laser casing connected to its center portion; and
a rotation drive belt connected to outer circumferential surfaces of the rotation drive pulley and rotation driven pulley.

6. The laser welding apparatus for square-shaped terminals according to claim 1, wherein the laser head unit is configured to rotate at an R value rotation center axis, which is a radius of curvature value of a curved section of the can and cap.

7. The laser welding apparatus for square-shaped terminals according to claim 2, wherein a laser transmission path of the laser casing is further provided with a protective glass and a nitrogen purge port.

8. The laser welding apparatus for square-shaped terminals according to claim 1, wherein the laser head unit is further provided with a cooling unit.

9. A laser welding method of square-shaped terminals using a laser welding apparatus for square-shaped terminals, including a rotation support frame, a laser head unit rotatably supported on the rotation support frame, and a rotation drive unit supported on the rotation support frame and rotating the laser head unit, the method comprising:
a linear section welding step of laser welding a linear welding section of a secondary battery square can and the cap by the laser head unit; and
a curved section welding step of rotating the laser head unit when the laser head unit reaches a curved section of the secondary battery square can and the cap to weld the curved section of the secondary battery square can and the cap.
